(19) United States
(12) Patent Application Publication
(10) Pub. No.: US 2022/0020096 A1
(43) Pub. Date: Jan. 20, 2022

(54) AN INFORMATION MANAGEMENT SYSTEM

(71) Applicant: Clifin Pty Ltd, Canning Vale, Western Australia (AU)

(72) Inventors: Ned Schepis, Canning Vale (AU); Gabriel Riccardo Ilarda, Clarkson (AU)

(21) Appl. No.: 17/298,517

(22) PCT Filed: Nov. 29, 2019
(86) PCT No.: PCT/AU2019/051311

§ 371 Date: May 28, 2021

(30) Foreign Application Priority Data
Nov. 29, 2018 (AU) 2018904547

(51) Int. Cl. G06Q 40/00; G06Q 40/08; G06Q 40/02; G06Q 40/06; G06F 16/25; G06F 9/54

(52) U.S. Cl. CPC G06Q 40/12; G06Q 40/08; G06F 9/54; G06Q 40/06; G06F 16/252; G06Q 40/025

(57) ABSTRACT

An information management system is disclosed for managing asset-related, liabilities-related, income-related and/or expenses-related information associated with a plurality of users. The system comprises a database arranged to store data representative of the asset-related, liabilities-related, income-related and/or expenses-related information, the data stored in a plurality of data tables, at least some of the data tables related to at least one other data table and the data tables including at least one primary data table associated with the respective asset-related, liabilities-related, income-related and/or expenses-related information. The system also comprises a database interface component arranged to interface with the database, the database interface component arranged to automatically identify asset-related, liabilities-related, income-related and/or expenses-related information in input data and to store the identified asset-related, liabilities-related, income-related and/or expenses-related information in at least one defined asset-related, liabilities-related, income-related and/or expenses-related primary data table such that defined asset-related, liabilities-related, income-related and/or expenses-related data intended to be shared is automatically identified and commonly stored. The system also comprises a user interface arranged to facilitate access to the data stored in the at least one primary data table by authorized users so as to enable the authorized users to access the stored data.

### FIELD OF THE INVENTION

The present invention relates to an information management system and to a method of managing information. The system and method has particular application for managing information associated with assets, liabilities, income and expenses.

### BACKGROUND OF THE INVENTION

Information management systems of the type arranged to store information specific to services in a particular industry sector are known. However, such systems are typically not integrated with each other, and typically require cumbersome duplication of information and therefore effort.

For example:
it is known to provide an accounting system arranged to manage financial information including income and expenses information, and to provide services in relation to the financial information, such as a user interface that facilitates display to a person of specific financial information based on user defined criteria;
it is known to provide a broker insurance system that enables a person to contact the insurance broker in order to submit a request for a quote (RFQ) for insurance, communicate the insurance quote to the person, and manage claims; and
it is known to provide an underwriter insurance system that enables an insurance broker to request a quote for insurance to an underwriter, to receive an insurance quote from the underwriter in response to the quote request, and manage claims.

However, such existing information management systems are independent of each other to the extent that in order to provide a person with information sought by the person, 3 separate systems are required, which necessitates re-entry of the same information into the multiple systems.

For example, in the example above, an insurance broker that receives information about the RFQ from the person seeking insurance is required to re-enter relevant received information into the underwriter insurance system, and to also re-enter quote information into the broker insurance system when quote information is received from the underwriter.

### SUMMARY OF THE INVENTION

In accordance with a first aspect of the present invention, there is provided an information management system for managing asset-related, liabilities-related, income-related and/or expenses-related information associated with a plurality of users, the system comprising:
a database arranged to store data representative of the asset-related, liabilities-related, income-related and/or expenses-related information, the data stored in a plurality of data tables, at least some of the data tables related to at least one other data table and the data tables including at least one primary data table associated with the respective asset-related, liabilities-related, income-related and/or expenses-related information;
a database interface component arranged to interface with the database, the database interface component arranged to automatically identify asset-related, liabilities-related, income-related and/or expenses-related information in input data and to store the identified asset-related, liabilities-related, income-related and/or expenses-related information in at least one defined asset-related, liabilities-related, income-related and/or expenses-related primary data table such that defined asset-related, liabilities-related, income-related and/or expenses-related data intended to be shared is automatically identified and commonly stored; and
a user interface arranged to facilitate access to the data stored in the at least one primary data table by authorized users so as to enable the authorized users to access the stored data.

In an embodiment, the database is a relational database.

In an embodiment, the database interface component comprises a plurality of application programming interfaces (APIs) usable to carry out actions in respect of the data stored in the database.

In an embodiment, the database interface component comprises at least one API arranged to carry out addition of data to the database, and/or movement of data and/or copying of data from at least one table in the database to at least one other table in the database.

In an embodiment, the database interface component comprises at least one API arranged to analyse input data and, in response to a defined trigger, to automatically identify and store asset-related, liabilities-related, income-related and/or expenses-related information in the at least one primary data table.

In an embodiment, the trigger comprises presence or absence of defined information in the input data.

In an embodiment, the trigger comprises presence or absence of defined information in at least one defined data field.

In an embodiment, the system is arranged to facilitate reception of information from a user using at least one defined form, and the trigger comprises presence or absence of defined information in a defined data entry field of the defined form.

In an embodiment, the system includes at least one primary asset-related table, at least one primary liabilities-related table, at least one primary income-related table and/or at least one primary expenses-related table.

In an alternative embodiment, the system includes at least one pillar table including a primary pillar table storing a record of asset, liability, income and expenses data, and at least one related pillar table defining characteristics of the asset, liability, income and expenses data.

In an embodiment, the system is arranged to retrieve stored asset-related data, liabilities-related data, income-related data and/or expenses-related data from the database, and to use the retrieved data to produce a client summary.

The client summary may include the total value of client assets, the total value of client liabilities, the total week/month/financial year client income and/or the total week/month/financial year client expenditure.

In an embodiment, the client summary is displayed to a user and the displayed client summary includes selectable asset, liabilities, income and/or expenses links that when selected cause detailed information associated with the asset, liabilities, income and/or expenses to be retrieved from the database and displayed to the user.

In an embodiment, the database includes stored data representative of a financial service, such as insurance, financial, mortgage, risk assessment, superannuation, investment, book keeping and/or stockbroking information related to the asset-related, liabilities-related, income-related and/or expenses-related information stored in at least one defined data table that is related to the asset-related, liabilities-related, income-related and/or expenses-related primary data table.

In an embodiment, the database is accessible by a financial service provider, such as an insurance service provider, a mortgage service provider, a stockbroking service provider, a superannuation service provider, a risk assessment service provider, an investment service provider, an accounting service provider and/or a book keeping service provider.

In an embodiment, the system is arranged to analyse data stored in the database and associated with a client, and to automatically produce recommendation indicia for the client based on the analysis, the recommendation indicia indicative of at least one recommended product or service.

In an embodiment, the recommendation indicia comprises a recommendation table comprising recommendation indicia indicative of at least one automatically recommended product or service, and the system is arranged to facilitate selection by an adviser user of at least one recommended product or service to be communicated to a client user.

In an embodiment, the recommendation indicia comprises a graphical device indicative of the at least one recommended product or service selected by the adviser user for communication to a client user.

In an embodiment, the graphical device comprises a substantially circular or annular graphical device comprising at least one section, each section indicative of a different recommended product or service. The at least one section may be represented differently according to whether the recommended product or service has been communicated to the client user and accepted by the client user, has been communicated to the client user but not yet accepted by the client user, or has been selected by the adviser user but not yet communicated to the client user, for example by colour coding the at least one section.

In an embodiment, the user interface includes a web server arranged to serve web pages to a user to enable the user to interact with the system using a web browser.

In an embodiment, the system is arranged to retrieve data for storage in the database from at least one remote data source in networked communication with the system, for example from a repository of stock-related information, and/or a financial institution.

In an embodiment, the authorized users comprise clients, advisers, licensees, and/or authorized representatives and/or suppliers of service providers.

In accordance with a second aspect of the present invention, there is provided a method of managing asset-related, liabilities-related, income-related and/or expenses-related information associated with a plurality of users, the method comprising:
storing in a database data representative of the asset-related, liabilities-related, income-related and/or expenses-related information, the data stored in a plurality of data tables, at least some of the data tables related to at least one other data table and the data tables including at least one primary data table associated with the respective asset-related, liabilities-related, income-related and/or expenses-related information;
providing a database interface component to interface with the database;
automatically identifying asset-related, liabilities-related, income-related and/or expenses-related information in input data;
automatically storing the identified asset-related, liabilities-related, income-related and/or expenses-related information in at least one defined asset-related, liabilities-related, income-related and/or expenses-related primary data table such that defined asset-related, liabilities-related, income-related and/or expenses-related data intended to be shared is automatically identified and commonly stored; and
facilitating access to the data stored in the at least one primary data table by authorized users so as to enable the authorized users to access the stored data.

### BRIEF DESCRIPTION OF THE DRAWINGS

The present invention will now be described, by way of example only, with reference to the accompanying drawings, in which:

FIG. 1 is a schematic block diagram of an information management system in accordance with an embodiment of the present invention;

FIG. 2 is a schematic block diagram illustrating components of an example implementation of an information management system in accordance with an embodiment of the present invention;

FIG. 3 is a diagrammatic representation of a structure of a portion of a database of the system shown in FIG. 2;

FIG. 4 is a flow diagram illustrating a process for creating an asset entity in the database of the system shown in FIG. 2;

FIG. 5 is a flow diagram illustrating a process for creating an asset subtype entity in the database of the system shown in FIG. 2, the asset subtype entity associated with a related asset entity;

FIG. 6 is a diagrammatic representation of a structure of tables of a database of the system shown in FIG. 2 that are associated with creation of a request for quote (RFQ) for insurance;

FIG. 7 is a schematic block diagram illustrating conceptual components of the example implementation shown in FIG. 2, the components relating to a specific use example;

FIG. 8 is a flow diagram illustrating an example request for quote (RFQ) lodgement process related to the specific use example shown in FIG. 7;

FIGS. 9 to 15 are example screens displayed to a user in order for the user to lodge a RFQ for insurance associated with a coffee shop/café or coffee roaster business;

FIGS. 16 to 19 are example screens displayed to a user for a RFQ, quote, policy and claim associated with insurance for a vehicle;

FIG. 20 shows an example insurance adviser recommendations screen for a fixed address business associated with a client of the insurance adviser;

FIG. 21 shows an example insurance adviser recommendations screen for a mobile business associated with a client of the insurance adviser; and

FIG. 22 is shows an example client profile analysis summary produced for a client by the system shown in FIG. 1.

FIG. 23 is a diagrammatic representation of a structure of tables of a database according to an alternative embodiment of the present invention; and

FIGS. 24 to 27 are example screens displayed by a financial data management tool that uses the database structure shown in FIG. 23.

### DESCRIPTION OF AN EMBODIMENT OF THE INVENTION

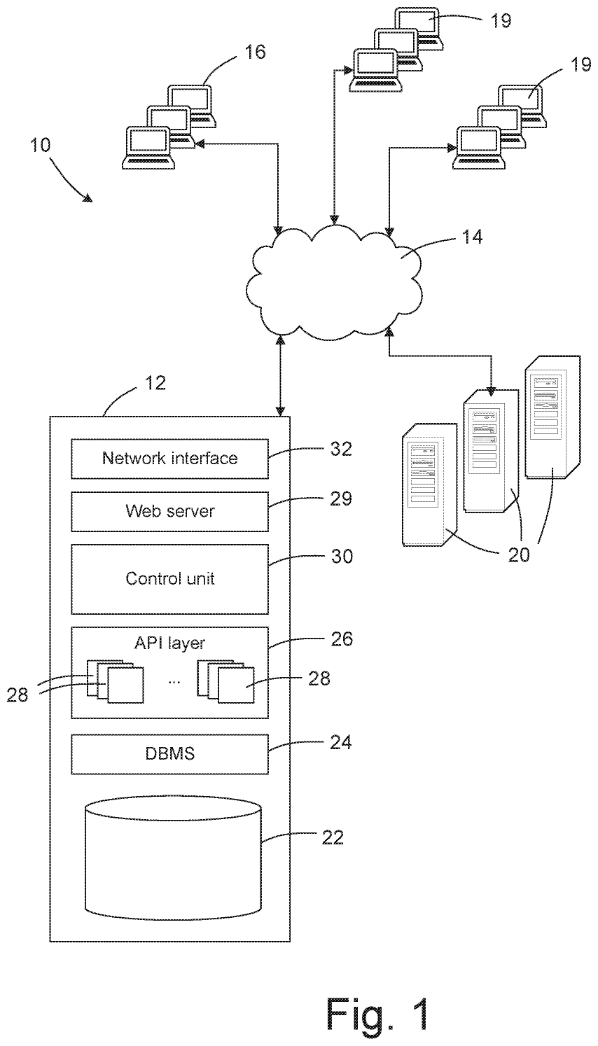

Referring to FIG. 1 of the drawings, there is shown an information management system 10 arranged to store and manage asset-related, liabilities-related, income-related and/or expenses-related information and enable the information to be used for personal, business, and/or services related uses, including insurance, business and/or financial services.

The system 10 in this example is implemented using an information management server 12 that is accessible through a wide area network (WAN), in this example the Internet 14, by computing devices 16 for example associated with individual users or users that are clients of service providers associated with the system 10, advisers 18, and service providers 19.

In this example, the server 12 is arranged to store data associated with multiple services, for example insurance data, financial data, accounting data, mortgage data and/or stock data, although it will be understood that any data associated with a service may be stored. The data is stored in a way that facilitates ease of sharing of defined asset-related, liabilities-related, income-related and/or expenses-related data with multiple services and/or entities, including multiple advisers and service providers, and ease of accessing and reporting on defined asset-related, liabilities-related, income-related and/or expenses-related data that is associated with multiple services and/or entities.

In this example, the server 12 is also in communication with at least one external data source 20 that stores data associated with a client, adviser or service provider that the client, adviser or service provider is authorized to access and import into the server 12. The at least one data source 20 may include at least one computing device, such as at least one server. For example, the at least one data source 20 may be associated with a financial organization, such as a bank, and the server 12 arranged to facilitate access to and downloading of financial data associated with one or more user account for storage at the server 12.

The server 12 may store authentication details for the or each data source 20 so as to enable the server 12 to access the data sources 20 and extract the required information.

The server 12 includes a database 22 that in this example is of relational type, the database 22 arranged to store the information desired to be managed, a database management application (DBMS) 24 arranged to provide an interface to the database 22, and an application programming interface (API) layer 26 that includes multiple APIs 28, the APIs serving to facilitate transactions with and manipulations of the entities and data in the database 22, for example so as to retrieve desired data, store data and create new data records.

The server 12 also includes a web server 29 arranged to serve web pages to a user web browser, for example in order to facilitate communication of information to the user and reception of data from the user using a defined user interface.

The server 12 also includes a control unit 30, for example implemented using a processor, for controlling and coordinating operations in the server 12, and a network interface 32 arranged to facilitate network communication between the server 12 and the Internet 14, and thereby the connected computing devices 16, 18, 19, 20.

In this example, the server 12 is implemented using any suitable computing device, and the client, adviser and service provider computing devices 16, 18, 19 are computing devices that may include personal computers, tablet computers and/or smartphones.

Using the user, client, adviser and service provider computing devices 16, 18, 19, data associated with a client, such as associated with insurance, personal, business and/or financial affairs of the client may be entered for storage in the database 22 by a user, client, adviser or service provider, and in response at least some defined asset-related, liabilities-related, income-related and/or expenses-related data is automatically stored in a defined structure in the database 22 such that the asset-related, liabilities-related, income-related and/or expenses-related data is stored at a common location and is thereby easily shareable, for example with other advisers and service providers. In addition, by storing all asset-related, liabilities-related, income-related and/or expenses-related data at a common location, the common location can be used as a source of all asset-related, liabilities-related, income-related and/or expenses-related data for an identity such as an individual, user, client or business.

Data associated with a client may also be obtained directly from the data sources 20 for storage in the database 22, with at least some defined asset-related, liabilities-related, income-related and/or expenses-related data being automatically stored in a common location in the database 22.

It will be understood that the server 12 is arranged to provide users with different dashboards that are specific to the users and representative of actions that the users are authorized to carry out. For example, an individual user may be able to view information relating to the user's affairs, enter RFQ requests and respond to quotes associated with the user, while an adviser user may be able to view information relating to the affairs of all clients associated with the adviser, and to communicate directly with multiple service providers such as multiple insurers.

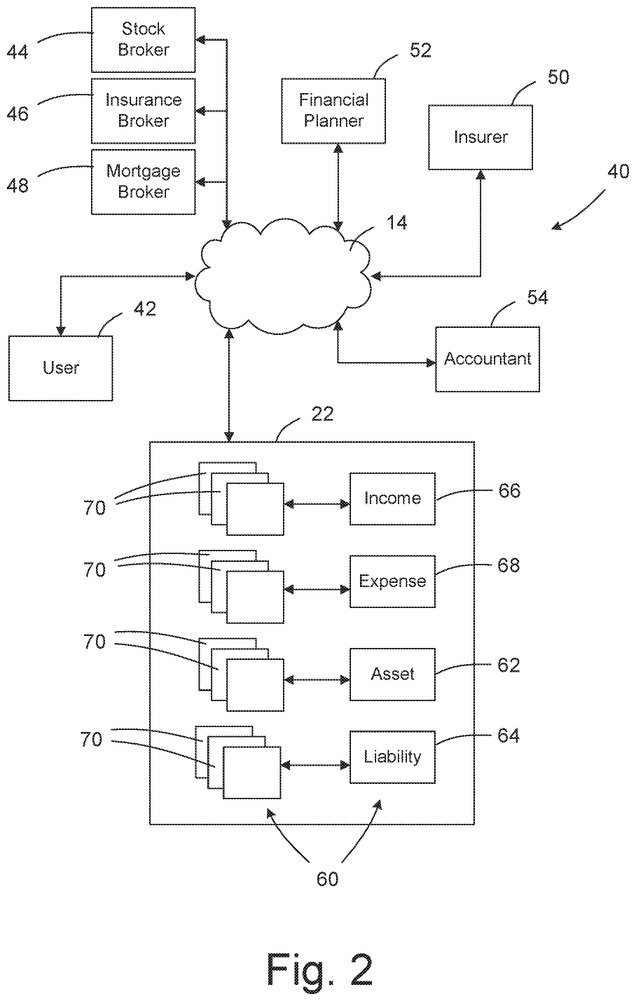

Components of an example implementation 40 of the information management system 10 are shown in FIG. 2.

The example implementation 40 includes a user 42 having insurance, financial, personal and/or business affairs that for example may include assets such as physical business assets, vehicle assets, personal property assets, and shares; insurance policies, including policies associated with assets; liabilities, for example associated with personal property and vehicle assets; and financial records associated with income and expenses information.

The example implementation 40 also shows advisers including a stock broker 44, an insurance broker 46, a mortgage broker 48 and a financial planner 52; an insurance service provider 50; and an accountant service provider 54. The advisers and service providers also have access to user data stored on the system.

The structure of data entities in the database 22 is shown, including multiple data entities 60 that include primary asset data entities 62, liability data entities 64, income data entities 66 and expense data entities 68; and secondary data entities 70 that are linked with the primary data entities 62, 64, 66, 68, indirectly linked with the primary data entities and/or linked with other secondary data entities 70.

It will be appreciated that the primary data entities 62, 64, 66, 68 represent important defined asset-related, liabilities-related, income-related and/or expenses-related data that is for example derived from multiple sources, and stored at a common location in the database 22 so that the data can be used as a common source of asset-related, liabilities-related, income-related and/or expenses-related data, for example for use by users and/or sharing with multiple entities, including multiple advisers and service providers. The secondary data entities 70 are linked directly or indirectly to the primary data entities 62, 64, 66, 68 in order to facilitate storage of data related to the primary data entities. For example, an asset entity may include a building asset record associated with a building such as a family home, and the building asset record linked to an insurance policy associated with the building, a mortgage associated with the building, and an insurance claim associated with the building. By structuring information in this way such that defined primary asset-related, liabilities-related, income-related and/or expenses-related data is separate from defined secondary data, the primary asset-related, liabilities-related, income-related and/or expenses-related data can be much more easily used and shared than with conventional information management systems known hitherto.

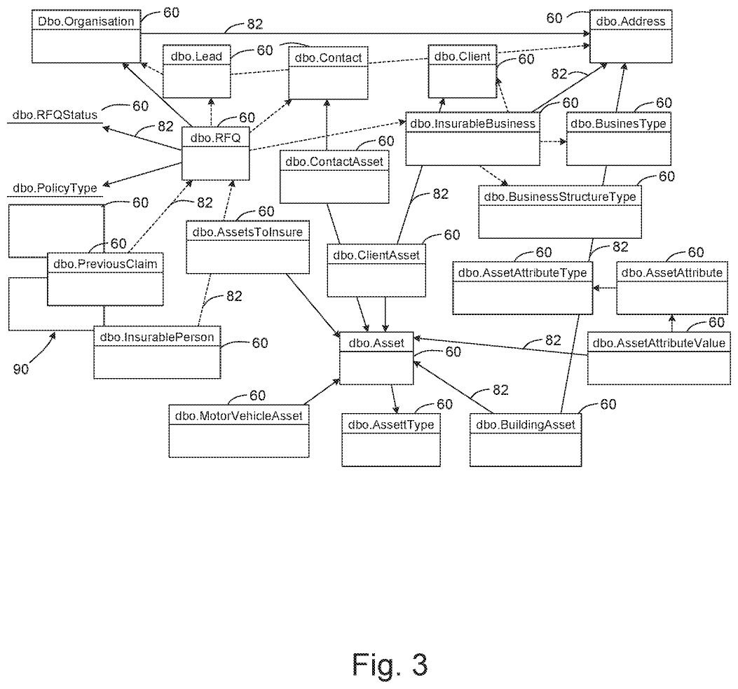

Referring to FIG. 3, a structure of a portion of the database 22 is shown that illustrates the relationships between some data entities 60 in the database 22. The data entities 60 shown in FIG. 3 are all associated with a request for quote (RFQ) for insurance. However, it will be understood that the database 22 also includes other data entities, for example associated with other insurance, financial, personal and/or business affairs of users.

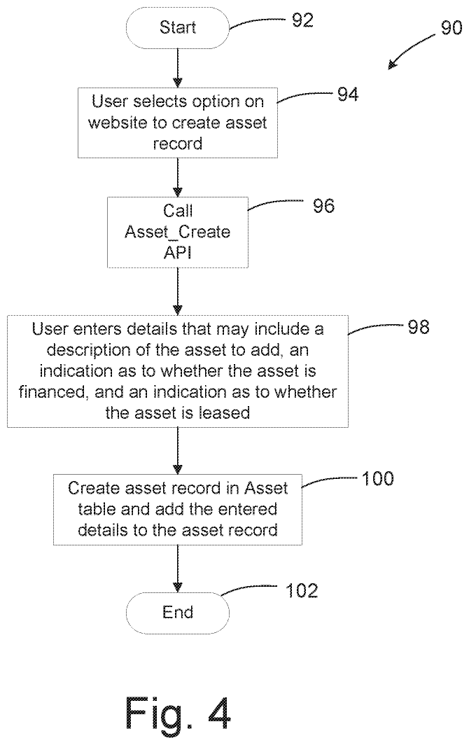

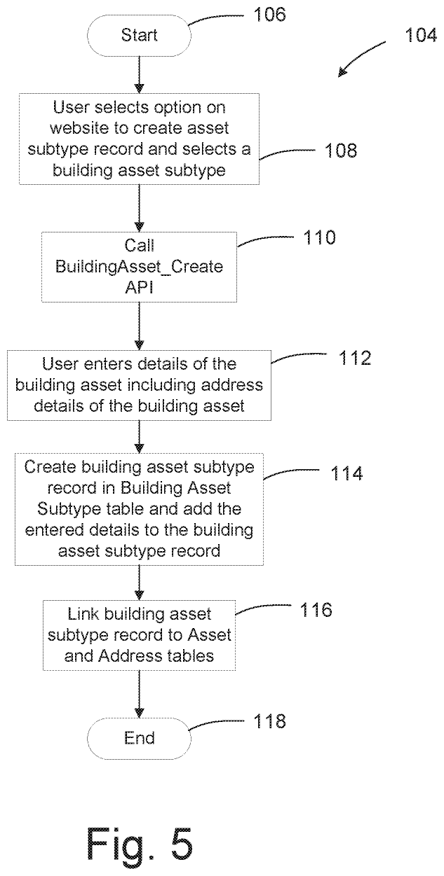

FIG. 4 shows a flow diagram 90 including steps 92 to 102 of a process for manually creating a primary data record, in this example an asset record associated with an asset entity in the database 22. FIG. 5 is a flow diagram 104 illustrating steps 106 to 118 of a process for creating an asset subtype record associated with an asset subtype entity and related to a relevant asset record.

The asset creation process may be instigated in any suitable way, for example by accessing the web server 29 using a web browser and creating asset data or downloading data that includes asset data, for example from a data source 20, such as a bank.

In order to manually create an asset record in the database, a user first selects an option as shown at step 94, for example on a website served by the web server 29, to create an asset record, for example because a user has acquired an asset, such as a property or vehicle, and the user or an adviser associated with the user wishes to add a record for the asset to the database 22. In response to the user selecting the asset creation option, an API 28 Asset_Create API is called, as shown at step 96, which causes fields to be displayed to the user to enable the user to add basic asset data, in this example including a description of the asset to add, an indication as to whether the asset is financed, and an indication as to whether the asset is leased.

As shown at step 100, an asset record associated with the asset entity is then created in the database 22. The asset record constitutes primary asset data, such as the asset type and market value, that is stored separately from other secondary data as a common source of asset data so that the asset data can more easily be used, shared and associated with other data.

In order to create an asset subtype record in the database that is related to the primary asset record and that provides further information about the asset, a user first selects an option as shown at step 108 in FIG. 5, for example on the website served by the web server 29, to create an asset subtype record to be linked to the asset record and selects the type of asset subtype. In this example, a building asset subtype is selected. In response to the user selecting the asset subtype creation option, an API 28 BuildingAsset_Create API is called, as shown at step 110, which causes fields to be displayed to the user to enable the user to add detailed asset data, in this example including address details of the building asset.

As shown at step 114, an asset subtype record associated with the asset subtype entity is then created in the database 22 and, as shown at step 116, the added building asset subtype record is linked to the relevant asset record in the database 22.

The stored asset information can be used for various purposes. For example, a user may view collated asset-related information, or the asset-related information may be used by service providers.

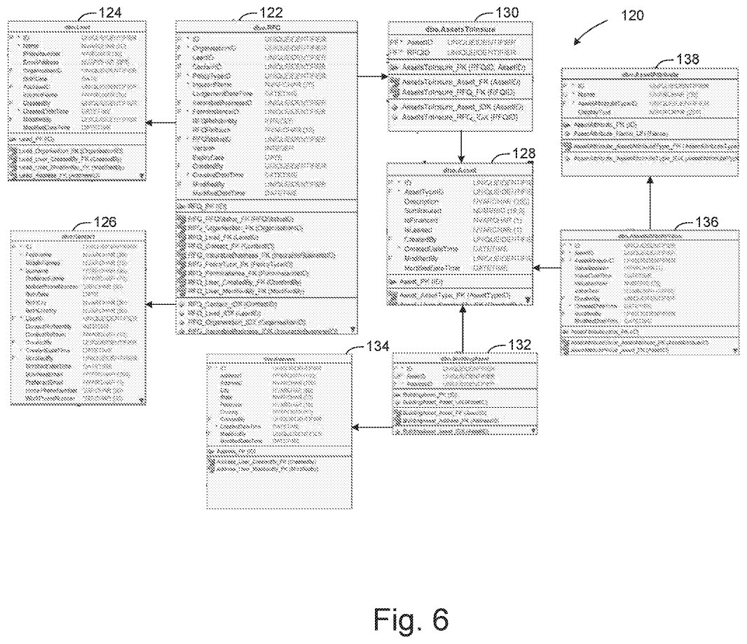

Referring to FIG. 6, an example is shown of a table structure in the database 22 that uses the asset-related information for a request for quote (RFQ) for insurance.

The data entities used for an insurance RFQ in this example include a RFQ entity 122, a lead entity 124, a contact entity 126, an asset entity 128, an assets to insure entity 130, a building asset entity 132, an address entity 134, an asset attribute value entity 136, and an asset attribute entity 138.

The RFQ entity 122 includes RFQ records used to store details of RFQ requests.

The lead entity 124 includes lead records used to store details of users that make RFQ requests but are not registered users of the system.

The contact entity 126 includes contact records used to store details of users registered with the system, including clients and advisers.

The asset entity 128 includes asset records used to store core asset data, in this example including a description of the asset, an asset type indicator, an indication as to whether the asset is financed, and an indication as to whether the asset is leased.

The assets to insure entity 130 is used to link the asset records to the RFQ records.

The building asset entity 132 is used to store asset subtype records associated with asset records that identify the asset type as a building.

The address entity 134 includes address records used to store details of addresses of building assets stored in building asset subtype records of the building asset entity 132.

The asset attribute entity 138 includes asset attribute records used to store details of asset attributes associated with the asset, and the asset attribute value entity 136 includes asset attribute value records used to store the actual asset values for the asset attributes referred to in the asset attribute records, including for example details of the market value of the asset, the type of building construction of a building asset, fire protection characteristics of the building asset, security details of the building asset, and so on.

It will be appreciated that the stored data associated with the asset entity 128, the building asset 132, the address entity 134, the asset attribute entity 138 and the asset attribute value entity 136 are separately stored, and at least some of the data in these data entities may represent primary data that is desired to be commonly used.

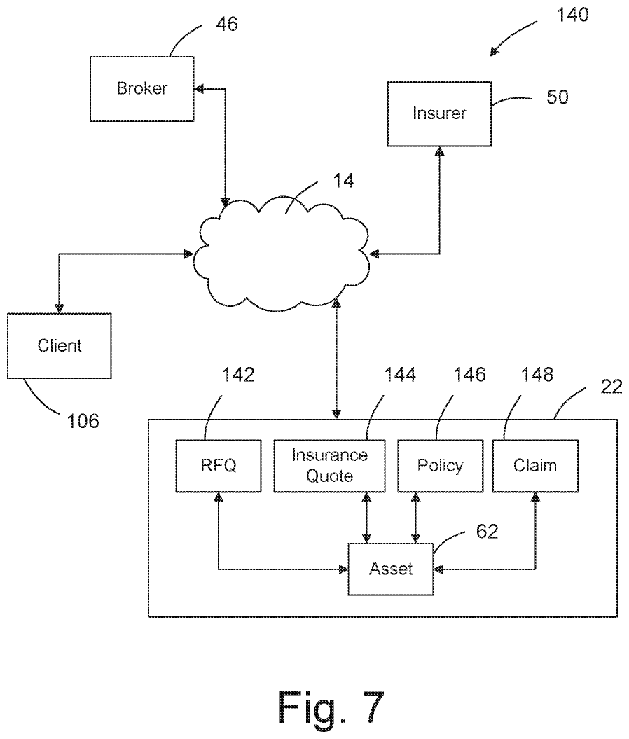

A specific example implementation from the perspective of an insurance service provider and in respect of insurance related information is shown in FIGS. 7 to 15. In this example, the system enables a user to lodge a request for quote (RFQ) for insurance associated with a coffee shop/café or coffee roaster business.

FIG. 7 illustrates components of an example information management system 140 from the perspective of an insurance service provider. Like and similar features are indicated with like reference numerals. For simplicity, only the database 22, a client 42, an insurance broker 46 and an insurance underwriter 50 are shown in networked communication with each other, and data entities associated with an asset 62 are shown in conceptual groups, including RFQ data entities 142 associated with an RFQ directly or indirectly linked to the asset 62, insurance quote data entities 144 associated with an insurance quote directly or indirectly linked to the asset 62, insurance policy data entities 146 associated with one or more insurance policies directly or indirectly linked to the asset 62, and insurance claim data entities 148 associated with at least one insurance claim directly or indirectly linked to the asset 62.

However, it will be appreciated that the information management system 140 may include other primary data entities associated with liabilities, income and/or expenses.

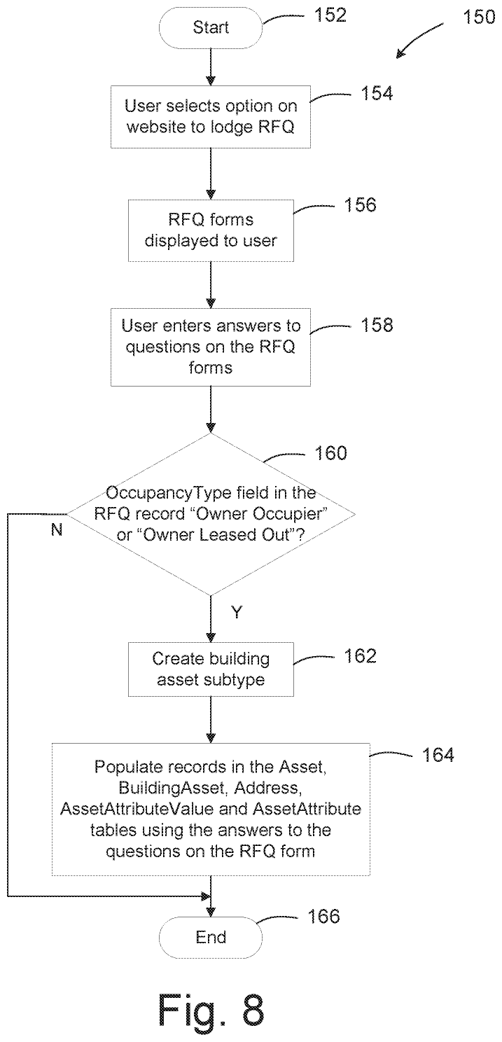

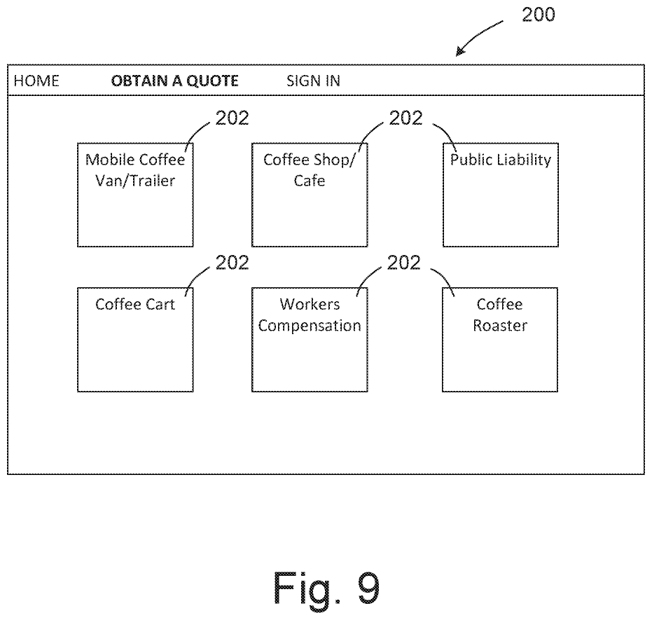

FIG. 8 shows a flow chart illustrating an example request for quote (RFQ) lodgement process using the example information management system 140 shown in FIG. 7, and FIGS. 9 to 15 show screens served to a user that facilitate creation and lodgement of the RFQ. In this example, the relevant service provider is associated with providing insurance for coffee providers and accordingly the insurance services available are associated with providers of coffee.

FIG. 9 shows a RFQ screen 200 that enables a user to select a type of insurance and for this purpose the RFQ screen 200 includes insurance type selection tiles 202 associated with a mobile coffee van/trailer, a coffee shop/café, a coffee cart, a coffee roasting business, public liability insurance and workers compensation insurance.

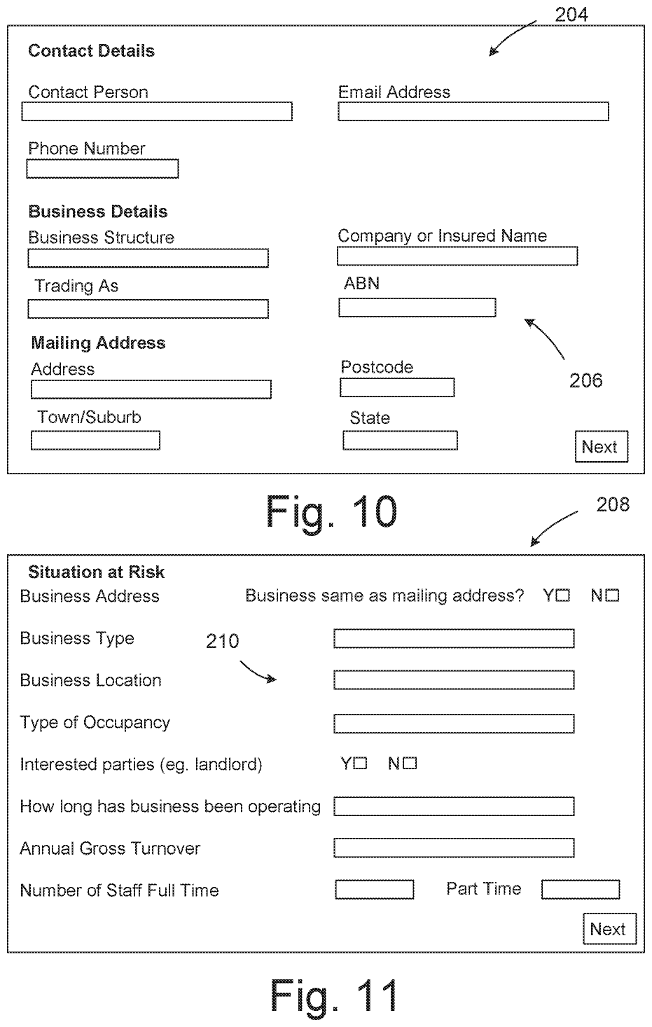

After a user has selected 154 one of the insurance type selection tiles 202, the user is presented 156 with at least one screen that enables the user to enter information 158 about the selected insurance type. In the present example, the user has selected a coffee shop/café, and as a consequence a contact details screen 204, as shown in FIG. 10, is displayed. The contact details screen 204 includes contact fields 206 usable to enter information, including information relating to the name, phone and email details of the contact person, name and address of the business, and contact details.

After the contact details have been entered using the contact details screen 204, an insured business screen 208 is displayed, as shown in FIG. 11.

The insured business screen 208 includes insured business fields 210 usable to enter information about the proposed insured business, including information about the business type; business location; type of occupancy, that is, whether the business is owner occupied, owner leased out or not; how long the business has been operating; annual gross turnover; and number of full time staff.

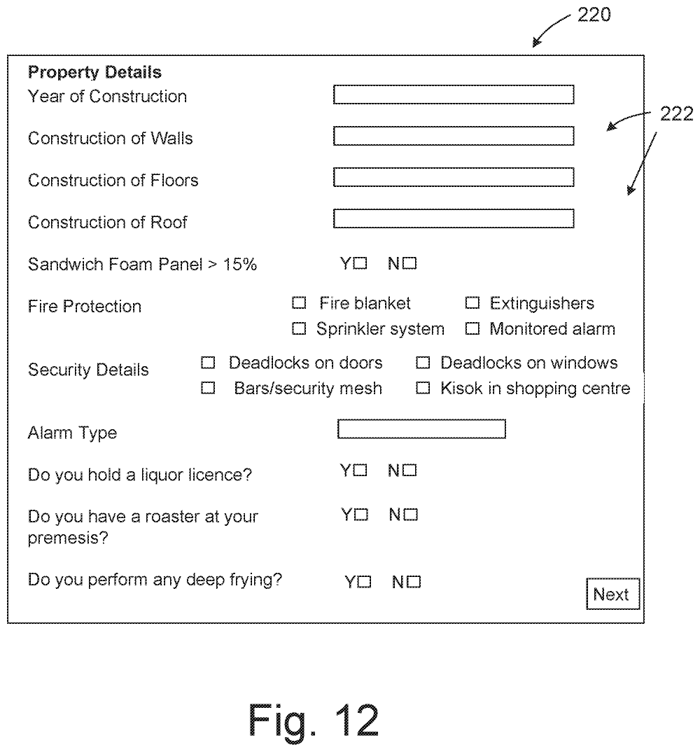

After the insured business details have been entered using the insured business screen 208, a property details screen 220 is displayed, as shown in FIG. 12.

The property details screen 220 includes property details fields 222 usable to enter information about the type of building associated with the proposed business insurance, including information about the year of construction; wall, floor and roof construction type; fire protection, security and alarm type details; whether a liquor licence exists; whether a coffee roaster is on the premises; and whether deep frying will occur at the property.

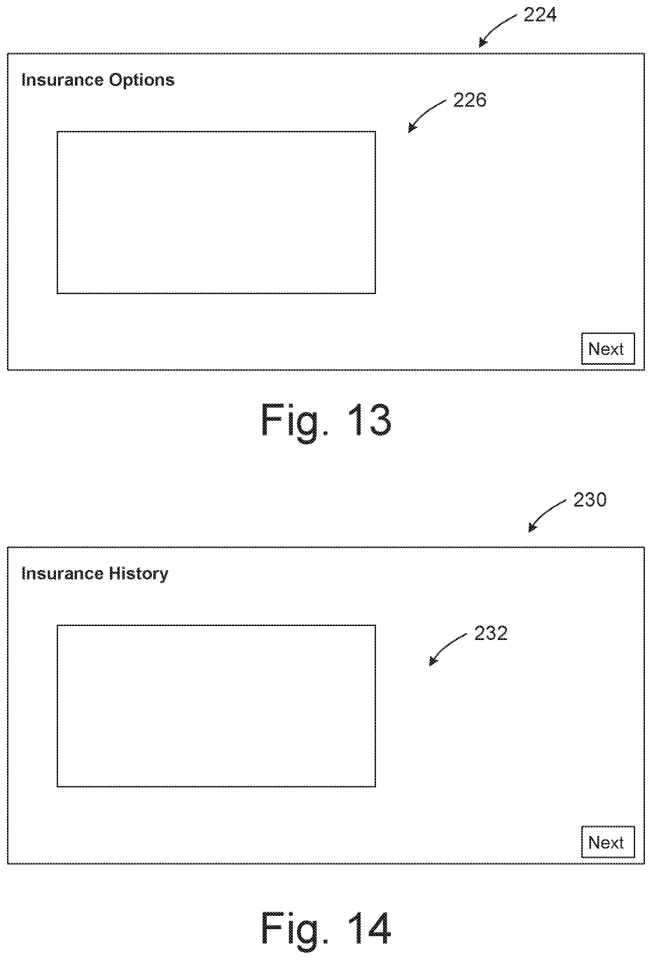

After the property details have been entered using the property details screen 220, an insurance options screen 224 is displayed, as shown in FIG. 13.

The insurance options screen 224 includes insurance options fields 226 usable to enter information about the type of insurance cover sought by the user, for example a sum insured amount; contents cover; stock cover; business interruption cover; public and product liability amount; machinery equipment cover; and so on.

After the insurance options have been entered using the insurance options screen 220, an insurance history screen 230 is displayed, as shown in FIG. 14.

The insurance history screen 230 includes insurance history fields 232 usable to enter information about the insurance history of the user, including information about whether insurance has ever been refused or cancelled; whether the user has ever been declared bankrupt; whether the user has ever been convicted of any crime; and whether any claims have been made against the user in the last 5 years.

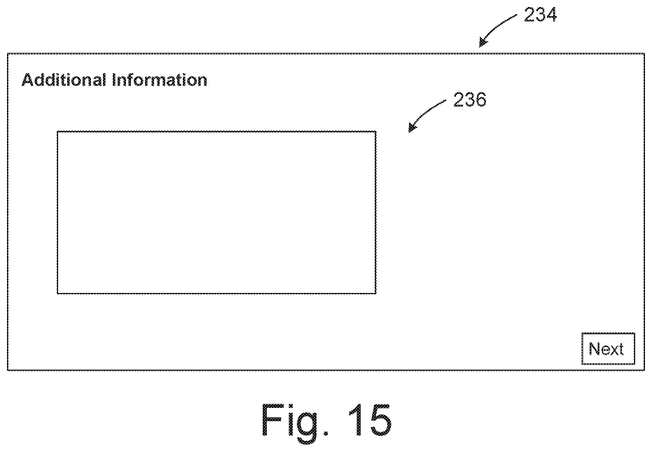

After the insurance history information has been entered using the insurance history screen 230, an additional information screen 234 is displayed, as shown in FIG. 15.

The additional information screen 234 includes additional information fields 236 usable to enter information about any additional cover that the user may need; whether the user would like to pay monthly; and any applicable promotional code.

In response to the user entering relevant information using the screens 200, 204, 208, 220, 224, 230 and 234 shown in FIGS. 9 to 15, the system calls relevant APIs 28 that cause the entered details to be stored in the database 22 in relevant tables of the relevant data entities.

For example, the address details associated with the business proposed to be insured are stored in a table associated with the address data entity 134 shown in FIG. 6, and details about the contact or lead are stored in a contact or lead table 124, 126 if the contact or lead does not exist in the contact or lead table 124, 126.

After entering the required RFQ information and storage of the information in the database 22, an RFQ communication is sent to the broker 46. The communication may be through the system 10 and/or may be sent as a separate communication such as an email to prompt the broker 46 to access the system 10, for example so that the broker 46 can prepare a RFQ for sending to a selected insurer 50.

Importantly, if the type of occupancy entered using the insured business screen 208 is owner occupied or owner leased out (which indicates that a client associated with the RFQ request owns the building), as indicated at step 160, and if the business asset is not already stored in the asset-related data entities, a relevant API 28 is called to create and populate 162, 164 an asset record in the asset data entity 128 and associated asset-related records in the assets to insure data entity 130, the building asset data entity 132, the address entity 134, the asset attribute value data entity 136 and the asset attribute data entity 138. The system 10 also links the relevant asset related records together, for example using record identifiers.

In this way, during the process of entering and lodging a RFQ request for business insurance wherein the business has an associated building, the system 10 uses APIs 28 to automatically recognize that a new asset (the building) exists that is not already stored in the database 22, and select relevant asset-related information from the information entered during the RFQ lodgement process for common storage in primary asset-specific tables. Automatically creating commonly usable asset-specific tables in the database 22 enables the asset-related information to be used as common asset-related information that can more easily be used by users, other business and/or financial advisers or other service providers. For example, the asset-specific tables may also be linked to an insurance policy and an insurance claim, financial information associated with a bank load, and so on.

In a further example process, an insurance adviser lodges an RFQ for insurance for a motor vehicle, and in response the system automatically identifies that asset-related information in the entered RFQ information, for example by identifying fields that specify vehicle characteristics, determines whether the asset is already stored in the database 22 and, if not, extracts relevant motor vehicle asset information entered using RFQ data entry screens, and creates a new asset in the relevant asset-related tables in the database 22. Since each record in the tables in the database 22 includes a unique identifier, the asset-related records are linked to each other using the unique table identifiers. The unique identifiers are also used to link the asset to other services in the system, so that it is not necessary to re-enter information related to the asset, and the asset related information is made commonly usable and easily shareable. For example, an insurance underwriter can use the same asset data to create an insurance policy record for the motor vehicle and to create an insurance claim record.

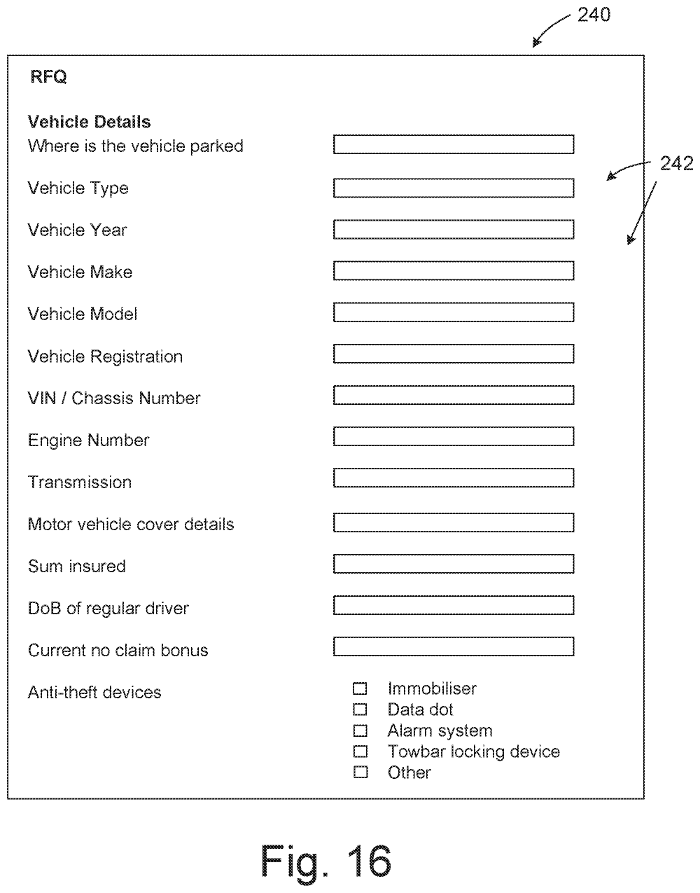

Example screens from the perspective of a provider of motor insurance and usable for an RFQ entry, a quote, a policy and a claim for a motor vehicle are shown in FIGS. 16 to 19.

FIG. 16 shows a RFQ screen 240 that is part of a request for quote (RFQ) process for vehicle insurance. The RFQ screen 240 includes vehicle details fields 242 usable by an adviser to enter details associated with a vehicle that is proposed to be insured.

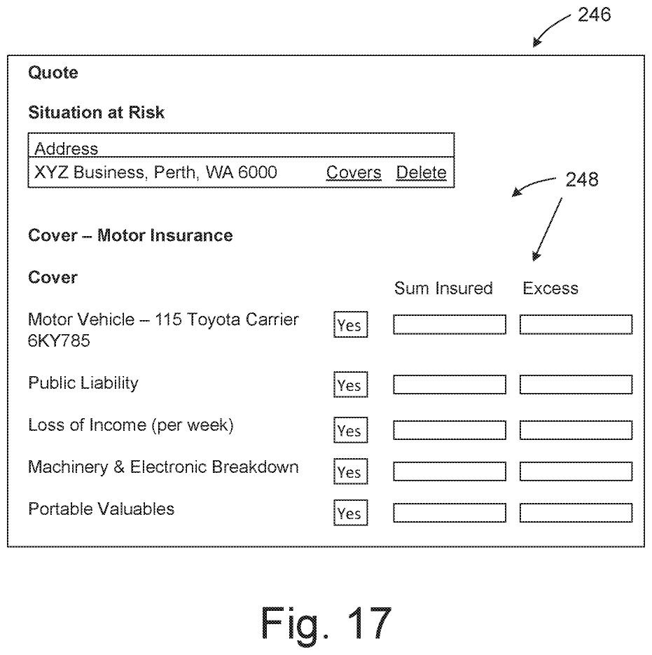

FIG. 17 shows a quote screen 246 for vehicle insurance, for example used by the adviser after a response to the RFQ has been received from an underwriter. The quote screen 246 includes quote fields 248 usable to enter details associated with the insurance quote.

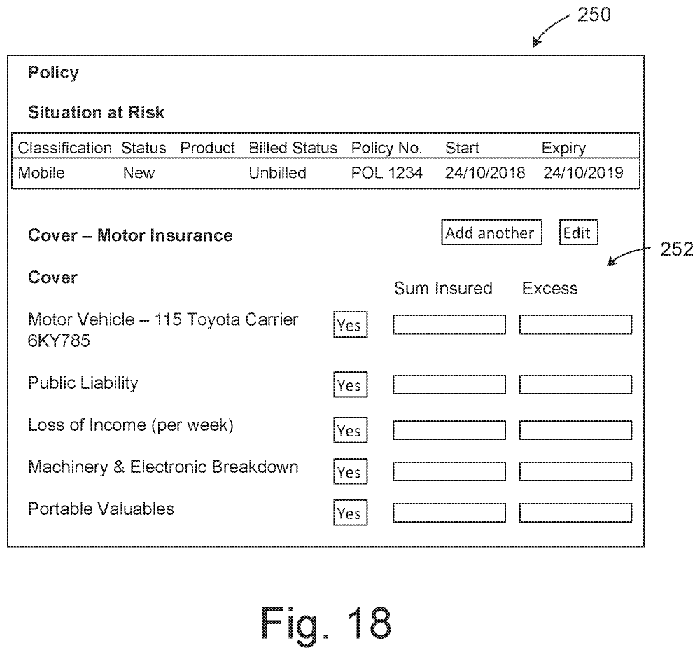

FIG. 18 shows a policy screen 250 that is for example created by the adviser after confirmation has been received from a client that the quoted insurance has been accepted by the client, for example because the client has accessed the system using a web browser and responded to a quote displayed on a dashboard associated with the client. The policy screen 250 includes policy details fields 252 usable to enter details associated with the created policy.

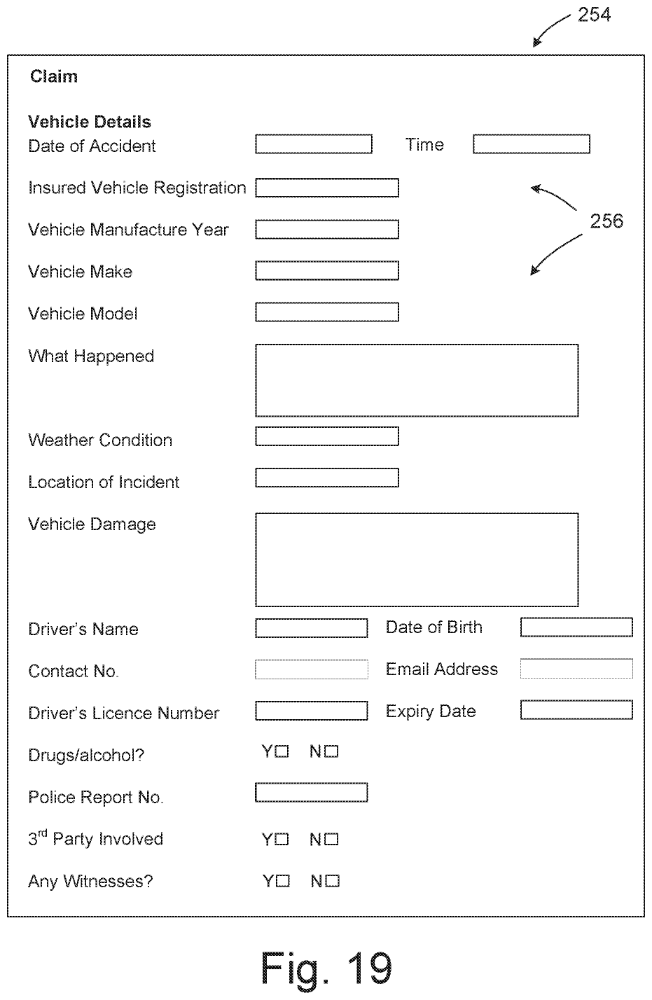

FIG. 19 shows a claims screen 254 that is for example created by the adviser after an insurance claim is desired to be made by a client. The claims screen 254 includes claim fields 256 usable to enter details associated with the claim.

It will be appreciated that each of the RFQ information, quote information, policy information and claims information entered using the RFQ screen 240, quote screen 246, policy screen 250 and claims screen 254 links to the same asset-related information that has been commonly stored, for example because the asset-related information has been automatically extracted from information entered during a RFQ process by recognizing asset-related information in specific asset related fields during the information entering or retrieval process.

It will also be appreciated that while the above examples are described in relation to asset-related primary data entities and insurance-related secondary data entities such as claims and policies-related data entities, other implementations are envisaged.

For example, mortgage-related secondary data entities may be linked to building asset-related data entities.

In a further example, a primary data record may be created in a primary data entity based on other obtained or entered data, such as financial transaction data retrieved from financial records. For example, if a user buys a vehicle, financial details of the purchase may be recorded in the database 22 by an accountant, for example in expense-related tables and/or liability-related tables. In response to recordal of the transaction to purchase the vehicle, the system may call one or more relevant APIs 28 that cause asset related information in the transaction information to be extracted and recorded in the asset-related tables in the database 22 so that the asset related information is stored in one or more dedicated common primary asset-related tables that can be easily used by other services.

In a further example, if a user buys a vehicle and the system is used to request a quote for insurance for the vehicle, in addition to adding data associated with the vehicle asset to the asset-related tables in the database 22, the system may call relevant APIs 28 that cause financial transaction data associated with purchase of the vehicle to be added to common expenses and/or liability related tables in the database so that the client's accounting records are kept up to date and the expenses and/or liability data may be commonly used by a user and/or service providers or advisers.

In a further example, a client's book keeper enters transactions associated with income from a rental property the client owns. In response, the system may call one or more relevant APIs 28 that cause rental income information in the transaction to be extracted and recorded in common income-related tables. The APIs 28 also cause the property to be added as an asset of the client in common asset-related tables. If the asset is to be financed, a liability record is also created in a common liability-related table.

In a further example, the system manually or automatically receives information about a bank transaction indicating that a new loan repayment is being made on a motor vehicle. In response, the system may call one or more relevant APIs 28 that cause asset information for the motor vehicle to be extracted and recorded in common asset-related tables, liability information associated with the loan to be recorded in common liability-related tables, and expense information associated with the repayment to be recorded in common expense-related tables. The expense, asset and liability data may also be sent to an accounting system.

In a further example, an accountant enters debt information for a client's office premises. In response, the system may call one or more relevant APIs 28 that cause asset information in the debt information to be extracted and recorded in common asset-related tables, liability information associated with the loan to be recorded in common liability-related tables, and expense information associated with the repayment to be recorded in common expense-related tables.

Example uses of the system will now be described wherein specific information is obtained from the system and used for specific purposes.

In a first example, an insurance adviser is provided with a tool for use in managing insurance products provided to or proposed to be provided to a person, the insurance tool extracting information for insurance purposes from the primary asset-related tables.

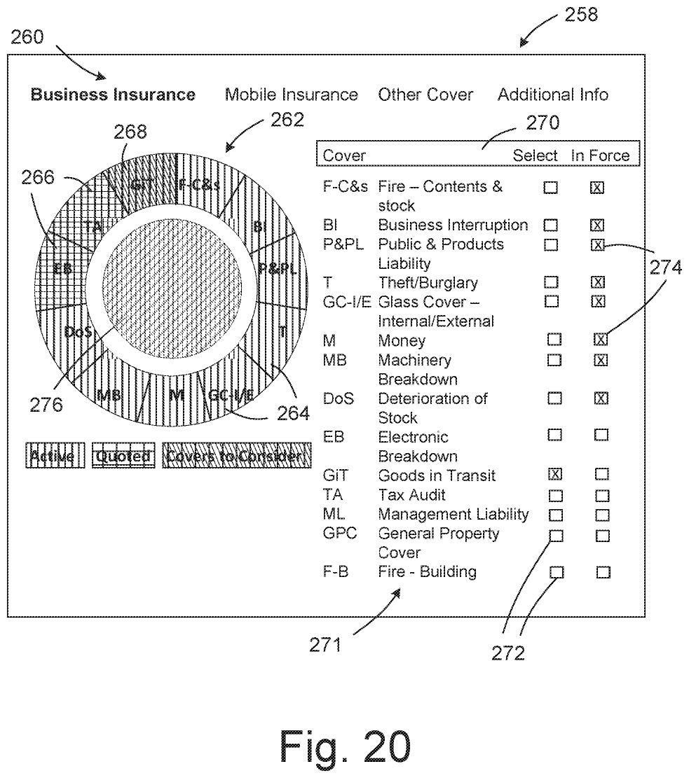

Referring to FIG. 20, a recommendation screen 258 is shown, in this example associated with an insurance adviser.

The recommendation screen 258 is used to provide the insurance adviser with information about insurance products that a client has, insurance products that have been proposed and quoted, and insurance products that the adviser has selected for recommendation to the client.

The recommendation screen 258 includes insurance type tabs 260 that enable an adviser to select an insurance category, in this example a business insurance category, a mobile insurance category, and an other cover category. Selection of each insurance type tab 260 causes display of information related to insurance products associated with the selected insurance type tab 260 for a particular client.

The recommendation screen 258 shown in FIG. 20 is displayed when a business insurance type tab 260 is selected and accordingly the suggested insurance products all relate to a fixed premises business.

The recommendation screen 258 also includes a recommendation table 270 that includes multiple suggested insurance products 271 that have been created by the system based on the asset information stored in the database for the client in the asset-related data entities. In this example, since the asset is a coffee shop, the insurance products listed in the recommendation table 270 all relate to insurance potentially required by the coffee shop owner.

The recommendation screen 258 also includes a graphical device 262, referred to in this specification as a ‘recommendation wheel’. The recommendation wheel 262 includes insurance type sections 264, 266, 268, each of which relates to an insurance product that has been selected by the adviser from the list of suggested insurance products 271 in the recommendation table 270. Selection of a suggested insurance product using checkboxes 272 causes the insurance product to appear in an insurance type section 264, 266, 268. A selected insurance product that has been accepted by the client and is in force is marked in an in force checkbox 274.

For example, in the present example, the proposed insurance products selected by the system include fire—contents and/or building; business interruption; public and products liability; theft; glass cover; money; machinery breakdown; deterioration of stock; electronic breakdown; goods in transit; tax audit; management liability; and general property cover.

The insurance type sections 264, 266, 268 include different visual indications, for example different colours, to indicate whether the relevant insurance product associated with the insurance type section is active 264 (for example green) because the client has opted to obtain the proposed insurance cover, pending 266 (for example orange) because a quote has been provided to the client but the client has not yet provided a response, and under consideration 268 (for example red) because the insurance product has been selected by the adviser for recommendation to the client, but a quote has not yet been sent to the client.

The recommendation wheel 262 also includes a workers compensation section 276 that is always included because all clients require workers compensation by default.

It will be understood that a similar screen to the recommendation screen 258 is also viewable by the client, so that the client is able to view existing and proposed insurance covers and select the proposed insurance cover that the client wants.

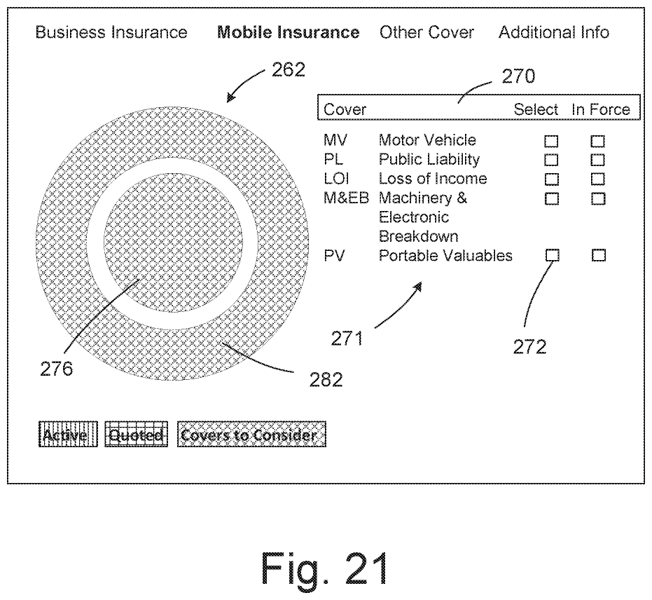

A further recommendation screen 280 is shown in FIG. 21. The further recommendation screen 280 is displayed when a mobile insurance type tab 260 is selected. Like and similar features are indicated with like reference numerals.

While a recommendation table 270 including suggested insurance products 271 is displayed, since the client does not have any mobile coffee vehicles, no checkboxes 272 have been selected by the adviser and a blank ring 282 is displayed to indicate that no proposed insurance products have been selected.

It will be understood that since no checkboxes 272 have been selected by the adviser, when the client accesses the system, the recommendation screen 280 associated with the mobile coffee vehicles will not be displayed.

In an example during use, if a user buys a vehicle and financial details of the transaction are recorded in the database 22 by an accountant, the system will call one or more relevant APIs 28 that cause asset related information in the transaction information to be extracted and recorded in the common asset-related tables in the database 22, and in response to recordal of the new asset, the recommended insurance cover for the vehicle asset will be listed in the suggested insurance products list 271 on the recommendation screen 280. However, in order to appear on the client recommendation wheel, the insurance adviser would need to select the relevant vehicle insurance checkbox 272 in the insurance products list 271.

It will also be appreciated that since a structured advisory process is provided by virtue of the recommendation wheel 262, the present system and method also provides good compliance management because recommendations provided by advisers are structured and documented.

In a further example, a financial summary tool is provided that extracts data from the assets, liabilities, income and expenses primary data entities and presents the information to a requestor. This is possible because the database has been structured to store primary asset-related, primary liabilities-related, primary income-related and primary expenses-related data in respective common locations in the database, and because relevant asset-related, liabilities-related, income-related and expenses-related data has been extracted from information provided to the system either manually or automatically for storage in the common locations.

It will be understood that since information associated with assets, liabilities, income and expenses are stored in the database 22 such that the information is linked to clients and readily accessible, it is possible to produce client information that summarises the client's business, personal and/or financial affairs by calling one or more suitable APIs 28 that extract the relevant asset, liabilities, income and expenses information from relevant common asset, liabilities, income and expenses-related tables in the database 22.

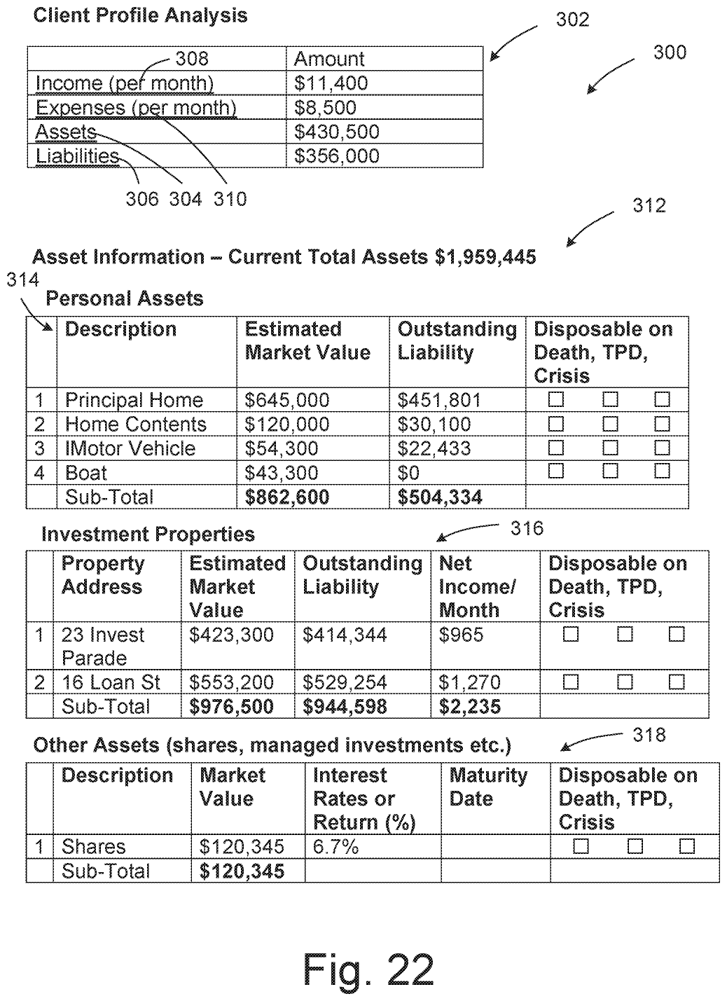

An example client profile analysis summary 300 for a client is shown in FIG. 22.

The client profile analysis summary 300 includes a summary table 302 that specifies the total value of assets associated with the client in the database 22, the total value of liabilities associated with the client in the database 22, the total monthly income received by the client (derived from financial information stored in the database 22), and the total monthly expenditure of the client (derived from financial information stored in the database 22).

The summary table 302 includes selectable assets, liabilities, income and expenses links 304, 306, 308, 310 that when selected cause more detail to be displayed.

For example, as shown in FIG. 22, when an asset link 304 is selected, an asset information table 312 is displayed. For the example client shown, the assets include personal assets 314, investment properties 316 and other assets 318 (in this example shares).

The personal assets information 314 includes a description of the asset, the estimated market value of the asset, the outstanding liability for the asset, and checkboxes to indicate whether the asset is disposable on death, total and permanent disablement (TPD) or personal crisis.

The personal assets information 314 is derived from relevant data entities in the database 22 that are linked together and associated with the client, including asset-related data entities and liability-related data entities. In addition, at least some of the information stored in the database 22 may have been initially obtained from an external data source 20. For example, the estimated market value of the asset may be derived from a bank, real estate source or insurer.

The investment properties information 316 includes an address of the property, the estimated market value of the property, the outstanding liability for the property, the net income per month that is associated with the property, and checkboxes to indicate whether the asset is disposable on death, total and permanent disablement (TPD) or personal crisis.

The investment properties information 316 is derived from relevant data entities in the database 22 that are linked together and associated with the client, including asset-related data entities, income-related data entities, and liability-related data entities. In addition, at least some of the information stored in the database 22 may have been initially obtained from an external data source 20. For example, the estimated market value of the asset may be derived from a bank, real estate source or insurer, and the net income may be derived from bank account records of the client.

The other assets information 318 includes details of the other asset, in this example shares, the market value of the property, the interest rate or return applicable to the asset, the maturity date of the asset if applicable, and checkboxes to indicate whether the asset is disposable on death, total and permanent disablement (TPD) or personal crisis.

The other assets information 318 is derived from relevant data entities in the database 22 that are linked together and associated with the client, including asset-related data entities. In addition, at least some of the information stored in the database 22 may have been initially obtained from an external data source 20. For example, the market value of the shares asset may be derived from a stock source.

The above embodiments are described in relation to a system that includes one or more asset-related tables, one or more liabilities-related tables, one or more income-related tables and one or more expenses-related tables that represent primary data for common use by users and any other entity including service providers. The above described embodiments are also configured so as to include functionality and database entities that may be specific to a service provider, such as functionality and database entities that are specific to an insurance service provider. In this way, the system includes both functionality related to storage and sharing of common asset, liability, income and expenses-related data and functionality related to systems that may use the common asset, liability, income and expenses-related data, such as systems specific to an insurance broker, insurance underwriter or financial service provider.

In an alternative embodiment, the information management system is arranged to manage only asset, liabilities, income and expenses related data, and to facilitate access to the system by others, including insurance and financial service providers.

In this way, the system includes functionality related to storage and sharing of common asset, liability, income or expense-related data and the system is arranged to interface with separate systems that may use the asset, liability, income or expense-related data, such as a separate insurance services system, and/or a separate financial services system. As a result, the system of this embodiment is more flexible and more readily scalable.

In addition, in the alternative embodiment, assets, liabilities, income and expenses are referred to as ‘pillars’ and in the present specification a ‘pillar’ will therefore be understood to mean an asset, liability, income or expense. The alternative embodiment is also arranged so as to include a core pillar table common to the assets, liabilities, income and expenses data, and related tables that for example defined the type of pillar (asset, liability, income or expense) and related information about the pillar, such as who owns the pillar, attributes of the pillar, value of the pillar, and so on. However, it will be understood that the alternative embodiment may also use separate asset, liability, income or expense-related data tables as used in the previous described embodiments.

It will be understood that in this example the alternative embodiment may include components and may implement functionality similar to the embodiments shown in FIGS. 1 to 22. For example, the alternative embodiment may also include components of the server 12 shown in FIG. 1, in particular an API layer 26 that manages interaction with the database 22 and a web server that facilitates remote interaction with the database 22.

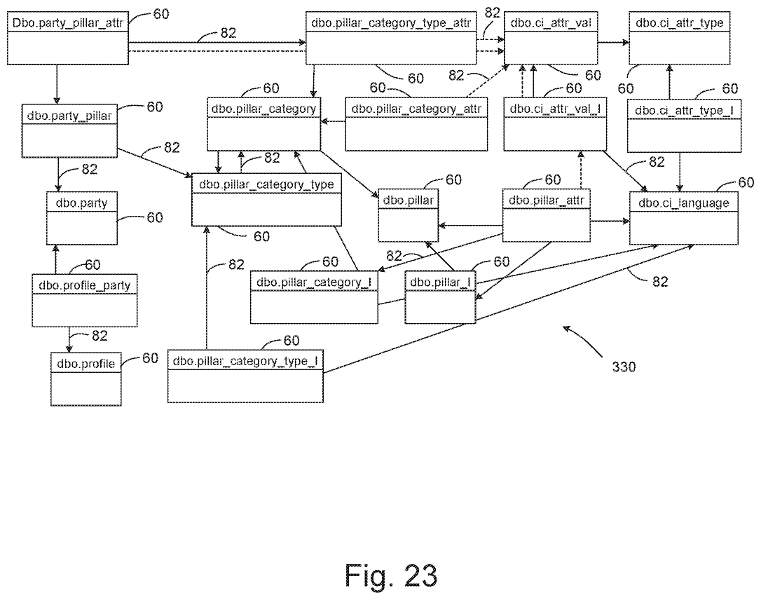

An example implementation of the alternative embodiment is shown in FIGS. 23 to 27. Like and similar features are indicated with like reference numerals.

FIG. 23 shows a structure 330 of a database 22 of the alternative embodiment that illustrates the relationships between data entities 60 in the database 22. The data entities 60 shown in FIG. 23 are all directly or indirectly associated with a pillar data entity.

For example, the data entities 60 include the following:
a pillar data entity that stores the income, expenses, assets and liabilities records.
a pillar category data entity that stores pillar category information indicative of the category of a pillar. Each pillar has a respective set of pillar categories. For example, for the asset pillar, the categories may be personal, investment properties and cash.
a pillar category type data entity that stores information indicative of pillar category types. Each pillar category has a respective set of pillar category types. For example, for the ‘asset’ pillar and asset category ‘personal’, the category types may include motor vehicle, property and boat.
a pillar category type attribute data entity that stores information indicative of attributes of pillar category types. Each pillar category type has a respective set of pillar category type attributes. For example, for the ‘asset’ pillar, asset category ‘personal’, and asset category type ‘motor vehicle’, the category type attributes may include year, make, model, market value, registration number and VIN.
a profile data entity that stores information indicative of a user profile.
a party data attribute that stores information indicative of the owner of a pillar.
a profile party data attribute that stores information indicative of a profile that may be associated with many parties. For example, a profile may be associated with multiple identities, such as a business that owns one or more pillars and an individual that may be associated with the business that owns one or more pillars. In this example, the profile party table includes a field called ‘share’ which is used to record a percentage that a particular profile owns in the party. For example, a profile ‘John Smith’ belongs to a party ‘John Smith’ and has 100% share, and/or a profile ‘John Smith’ belongs to a party ‘John and Mary Smith Family Trust’ and has a 50% share in the party ‘John and Mary Smith Family Trust’.
a party pillar entity that stores information indicative of the pillar category types that party owns. For example, for the asset pillar, the party pillar may store a record of a link between party ‘John Smith’ and a motor vehicle personal asset.
a party pillar attribute data entity that stores attributes values for a pillar. For example, for the ‘asset’ pillar, the party pillar data entity records that a party ‘John Smith’ owns a motor vehicle asset, the pillar category type attribute data entity stores information about the attributes of the motor vehicle category type, and the party pillar attribute data entity stores values of the attributes of the motor vehicle category type, such as for example Year: 2015, Make: BMW, Model: X5, Market Value: $93,000, Registration: 1X5FAST, VIN: 43298HGDJDJD43H
a configuration item (CI) attribute type data entity that is a generic table used to store attributes for all entities in the model. The data entity includes a flag AGGR_FLAG that accepts 0 and 1. If the flag is set to 1, a system API uses this attribute to aggregate information in the pillar, pillar category and/or pillar category type data entities.

It will be understood that this structure facilitates ease of extraction and collation of financial information associated with a person or party with which the person is associated, ease of extraction and collation of financial information associated with one or more of the pillars (assets, liabilities, income or expenses), and ease of extraction of information associated with specific pillar records.

For example, if a party ‘John Smith’ has 2 Motor Vehicles—a BMW with a market value of $93,000 and a Toyota with market value of $13,000, and property with market value of $400,000, the following information will be stored in the database entities for the assets;
Pillar Category data entity includes a record for a ‘personal’ pillar asset;
Pillar Category Type data entity includes records for a motor vehicle and property;
Party Pillar Attribute Data entity includes attribute values $106,000 for the motor vehicle and $400,000 for the property.

Searching in the pillar category data entity for ‘personal’ pillars and limiting to pillar records owned by party ‘John Smith’ would enable all values associated with personal property owned by party ‘John Smith’ to be viewed, in this example $506,000.

The system having the database structure 330 shown in FIG. 23 may be accessible by a separate financial data management tool for managing assets, liabilities, income and expenses data for a party such as an individual or business, for example using suitable APIs.

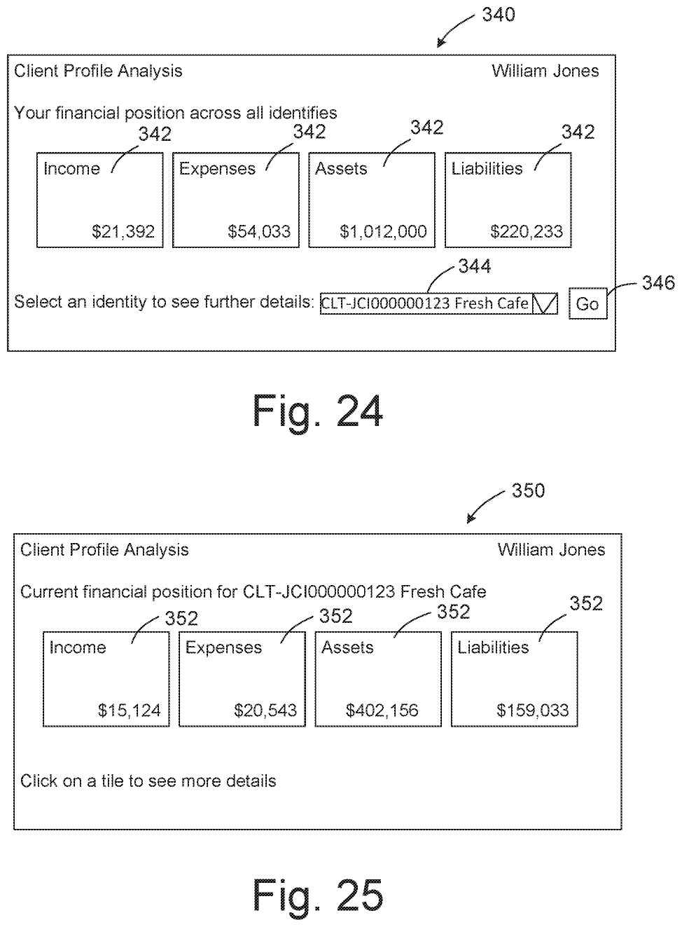

FIGS. 24 to 27 show example screens displayed to a user by the financial data management tool that is separate to and in communication with an information management system having the database structure 330 shown in FIG. 23.

As shown in FIG. 24, when a user, in this example William Jones, logs into the system, a home page 340 is displayed that shows a summary of the total financial amount associated with each pillar—assets, liabilities, income and expenses. Each pillar value represents a sum of the total pillar values across all parties (identities) associated with a login profile. In this example, the profile associated with the current log in account has an individual identity ‘William Jones’ and a company identity ‘Fresh Café’. Each of the pillars is shown on a tile 342 whereby selection of a tile by the user causes more detail about the pillar to be displayed.

The home page 340 also includes an identity selection drop down box 344 usable to select an identity associated with the profile, and an activation button 346 that when selected causes an identity financial summary screen 350 to be displayed, as shown in FIG. 25. As shown, the user has selected the ‘Fresh Café’ identity and the identity financial summary screen 350 shows a summary of the total financial amount associated with the assets, liabilities, income and expenses pillars for the identity ‘Fresh Café’.

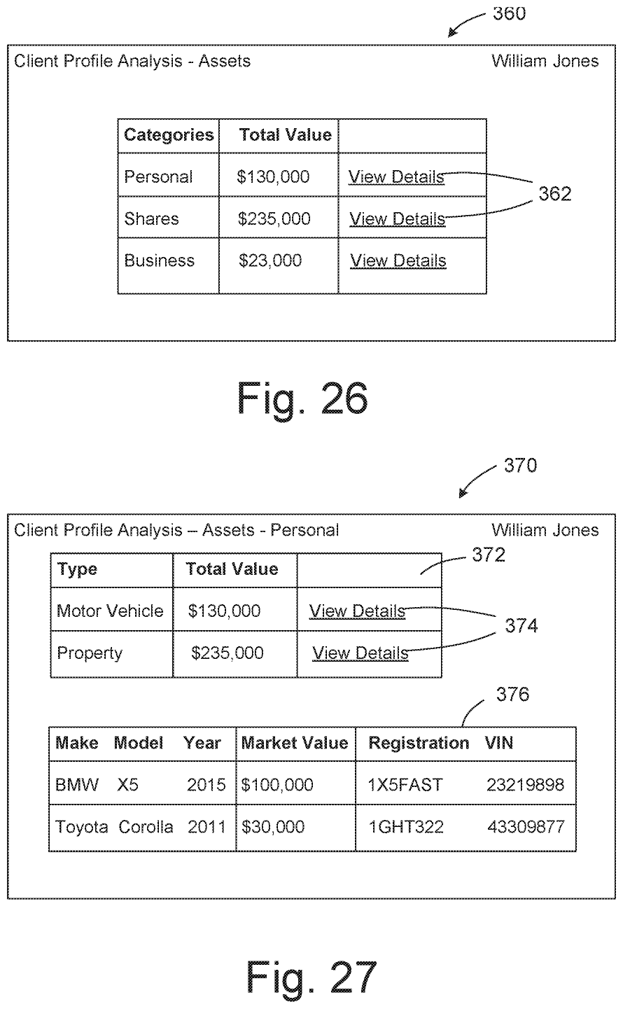

If a user selects a tile 342 on the home page 340 or a tile 352 on the identity financial summary screen 350, a pillar summary screen 360 is displayed, as shown in FIG. 26. The pillar summary screen 360 includes a list of all pillar categories associated with the current profile or specific identity. In the present example, a user has selected the asset pillar tile 342 on the home page 340, and therefore all asset categories associated with the login profile are displayed, in this example personal property having a total value of $130,000, shares having a total value of $235,000 and a business having a total value of $23,000.

If a user selects a view details link 362, a pillar category summary screen 370 is displayed, as shown in FIG. 27. The pillar category summary screen 370 includes details of the selected pillar category in a pillar category table 372. In this example, the user has selected the view details link 362 associated with the personal pillar category, and as such the pillar category table 372 includes details of the personal assets associated with the identity, in this example motor vehicles and property.

Selection of a view details link 374 on the pillar category summary screen 370 causes a pillar details table 376 to be displayed. In this example, a view details link 374 associated with the motor vehicles category type has been selected and as such details of the motor vehicles owned by the identity are displayed in the pillar details table 376.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are determined to be within the scope of the present invention.

1. An information management system for managing asset-related, liabilities-related, income-related and expenses-related information associated with a plurality of users, the system comprising:
a database arranged to store data representative of the asset-related, liabilities-related, income-related and/or expenses-related information, the data stored in a plurality of data tables, at least some of the data tables related to at least one other data table and the data tables including at least one primary data table associated with the respective asset-related, liabilities-related, income-related and/or expenses-related information;
a database interface component arranged to interface with the database, the database interface component arranged to automatically identify asset-related, liabilities-related, income-related and/or expenses-related information in input data and to store the identified asset-related, liabilities-related, income-related and/or expenses-related information in at least one defined asset-related, liabilities-related, income-related and/or expenses-related primary data table such that defined asset-related, liabilities-related, income-related and/or expenses-related data intended to be shared is automatically identified and commonly stored; and
a user interface arranged to facilitate access to the data stored in the at least one primary data table by authorized users so as to enable the authorized users to access the stored data.

2. (canceled)

3. An information management system as claimed in claim 1, wherein the database interface component comprises a plurality of application programming interfaces (APIs) usable to carry out actions in respect of the data stored in the database, and the database interface component comprises at least one API arranged to carry out any one or more of: addition of data to the database, movement of data from at least one table in the database to at least one other table in the database, copying of data from at least one table in the database to at least one other table in the database.

4. (canceled)

5. An information management system as claimed in claim 3, wherein the database interface component comprises at least one API arranged to analyse input data and, in response to a defined trigger, to automatically identify and store asset-related, liabilities-related, income-related, or expenses-related information in the at least one primary data table.

6. An information management system as claimed in claim 5, wherein the trigger comprises any one or more of:
presence or absence of defined information in the input data; and
presence or absence of defined information in at least one defined data field.

7. (canceled)

8. An information management system as claimed in claim 6, wherein the system is arranged to facilitate reception of information from a user using at least one defined form, and the trigger comprises presence or absence of defined information in a defined data entry field of the defined form.

9. An information management system as claimed in claim 1, wherein the system includes at least one primary asset-related table, at least one primary liabilities-related table, at least one primary income-related table and/or at least one primary expenses-related table.

10. An information management system as claimed in claim 1, wherein the system includes at least one pillar table including a primary pillar table storing a record of asset, liability, income and expenses data, and at least one related pillar table defining characteristics of the asset, liability, income and expenses data, and wherein the system is arranged to retrieve stored asset-related data, liabilities-related data, income-related data and/or expenses-related data from the database, and to use the retrieved data to produce a client summary.

11. (canceled)

12. An information management system as claimed in claim 10, wherein the client summary includes the total value of client assets, the total value of client liabilities, the total week/month/financial year client income and/or the total week/month/financial year client expenditure.

13. (canceled)

14. An information management system as claimed claim 1, wherein the database includes stored data representative of insurance, financial, mortgage, risk assessment, superannuation, investment, book keeping and/or stockbroking information related to the asset-related, liabilities-related, income-related and/or expenses-related information stored in at least one defined data table that is related to the asset-related, liabilities-related, income-related and/or expenses-related primary data table, and controlled access can be granted to is accessible by an insurance service provider, a mortgage service provider, a stockbroking service provider, a superannuation service provider, a risk assessment service provider, an investment service provider, an accounting service provider and/or a book keeping service provider.

15. (canceled)

16. An information management system as claimed in claim 14, wherein the system is arranged to analyse data stored in the database and associated with a client, and to automatically produce recommendation indicia for the client based on the analysis, the recommendation indicia indicative of at least one recommended product or service.

17. An information management system as claimed in claim 16, wherein the recommendation indicia comprises a recommendation table comprising recommendation indicia indicative of at least one automatically recommended product or service, and the system is arranged to facilitate selection by an adviser user of at least one recommended product or service to be communicated to a client user.

18. (canceled)

19. An information management system as claimed in claim 17, wherein the graphical device comprises a substantially circular or annular graphical device comprising at least one section, each section indicative of a different recommended product or service.

20. (canceled)

21. (canceled)

22. An information management system as claimed in claim 1, wherein the user interface includes a web server arranged to serve web pages to a user to enable the user to interact with the system using a web browser.

23. An information management system as claimed in claim 1, wherein the system is arranged to retrieve data for storage in the database from at least one remote data source in networked communication with the system.

24. (canceled)

25. A method of managing asset-related, liabilities-related, income-related and/or expenses-related information associated with a plurality of users, the method comprising:
storing in a database data representative of the asset-related, liabilities-related, income-related and/or expenses-related information, the data stored in a plurality of data tables, at least some of the data tables related to at least one other data table and the data tables including at least one primary data table associated with the respective asset-related, liabilities-related, income-related and/or expenses-related information;
providing a database interface component to interface with the database;
automatically identifying asset-related, liabilities-related, income-related and/or expenses-related information in input data;
automatically storing the identified asset-related, liabilities-related, income-related and/or expenses-related information in at least one defined asset-related, liabilities-related, income-related and/or expenses-related primary data table such that defined asset-related, liabilities-related, income-related and/or expenses-related data intended to be shared is automatically identified and commonly stored; and
facilitating access to the data stored in the at least one primary data table by authorized users so as to enable the authorized users to access the stored data.

26. (canceled)

27. (canceled)

28. (canceled)

29. A method as claimed in claim 25, comprising analysing input data and, in response to a defined trigger, automatically identifying and store asset-related, liabilities-related, income-related, or expenses-related information in the at least one primary data table, and wherein the trigger comprises any one or more of:
presence or absence of defined information in the input data;
presence or absence of defined information in at least one defined data field.

30. (canceled)

31. (canceled)

32. (canceled)

33. (canceled)

34. A method as claimed in claim 32, comprising building at least one pillar table including a primary pillar table storing a record of asset, liability, income and expenses data, and at least one related pillar table defining characteristics of the asset, liability, income and expenses data.

35. A method as claimed in claim 34, comprising retrieving stored asset-related data, liabilities-related data, income-related data and/or expenses-related data from the database, and using the retrieved data to produce a client summary, wherein the client summary includes the total value of client assets, the total value of client liabilities, the total monthly client income and/or the total monthly client expenditure.

36. (canceled)

37. A method as claimed in claim 35, wherein the client summary is displayed to a user and the displayed client summary includes selectable asset, liabilities, income and/or expenses links that when selected cause detailed information associated with the asset, liabilities, income and/or expenses to be retrieved from the database and displayed to the user.

38. A method as claimed in claim 37, wherein the database includes stored data representative of insurance, financial, mortgage, risk assessment, superannuation, investment, book keeping and/or stockbroking information related to the asset-related, liabilities-related, income-related and/or expenses-related information stored in at least one defined data table that is related to the asset-related, liabilities-related, income-related and/or expenses-related primary data table, and the method further comprises;
controlling access to the database by any or nor more of: an insurance service provider, a mortgage service provider, a stockbroking service provider, a superannuation service provider, a risk assessment service provider, an investment service provider, an accounting service provider and/or a book keeping service provider; and
analysing data stored in the database and associated with a client, and automatically producing recommendation indicia for the client based on the analysis, the recommendation indicia indicative of at least one recommended product or service.

39-48. (canceled)

49. An information management system as claimed in claim 12, wherein the client summary is displayed to a user and the displayed client summary includes selectable asset, liabilities, income and/or expenses links that when selected cause detailed information associated with the asset, liabilities, income and/or expenses to be retrieved from the database and displayed to the user

50. An information management system as claimed in claim 17, wherein the recommendation indicia comprises a graphical device indicative of the at least one recommended product or service selected by the adviser user for communication to a client user.

51. An information management system as claimed in claim 19, wherein the at least one section is represented differently according to whether the recommended product or service has been communicated to the client user and accepted by the client user, has been communicated to the client user but not yet accepted by the client user, or has been selected by the adviser user but not yet communicated to the client user
